(19) United States
(12) Patent Application Publication
(10) Pub. No.: US 2024/0222655 A1
(43) Pub. Date: Jul. 4, 2024

(54) FLOW FIELD PLATE FOR A FUEL CELL OR A REDOX FLOW BATTERY, HAVING A HYDROPHOBIC SURFACE REGION, AND METHOD FOR PRODUCING SAID FLOW FIELD PLATE

(71) Applicant: SCHUNK KOHLENSTOFFTECHNIK GMBH, Heuchelheim (DE)

(72) Inventors: Hauke VOORMANN, Linden (DE); Dominik WITTKA, Bischoffen (DE)

(73) Assignee: SCHUNK KOHLENSTOFFTECHNIK GMBH, Heuchelheim (DE)

(21) Appl. No.: 18/557,986

(22) PCT Filed: May 18, 2021
(86) PCT No.: PCT/EP2021/063204

§ 371 Date: Oct. 30, 2023

(51) Int. Cl. H01M 8/0258; H01M 8/0213; H01M 8/18

(52) U.S. Cl. CPC H01M 8/0258; H01M 8/0213; H01M 8/188

(57) ABSTRACT

A bipolar plate for a fuel cell or a flow battery. The bipolar plate includes a substrate and a channel running from a channel entrance at a surface of the substrate into an interior of the substrate. A surface of the substrate is more strongly hydrophobic in a first area inside the channel adjacent to the channel entrance than in a second area. Among other things, this may prevent moisture from entering the channel and accumulating there.

### FIELD

The present invention relates to a bipolar plate of a fuel cell or flow battery and a method of manufacturing such a bipolar plate.

### BACKGROUND

Bipolar plates are intended to perform several different tasks for fuel cells, which are stacked to form a core of a fuel cell system. On the one hand, they are intended to interconnect adjacent fuel cells, i.e. to physically and electrically connect an anode of one cell with a cathode of an adjacent cell. On the other hand, it should be possible to distribute gas towards reaction spaces within the fuel cells across a surface of the bipolar plate, i.e. the bipolar plate should convey reaction gases into reaction zones. For this purpose, the bipolar plate typically has flow profiles (so-called flow fields) on both sides, which may be milled, cast or formed and through which hydrogen flows on one side and air is supplied on the other side. The bipolar plate generally also controls the removal of water vapour or the release of thermal and electrical energy. Furthermore, the bipolar plate should also provide gas separation between adjacent cells, a seal to the outside and cooling if necessary.

Bipolar plates often have channels running through an interior of a substrate of the bipolar plate. Such channels can, for example, perform certain tasks during the production of the bipolar plate. For example, an adhesive may be accommodated within such channels, with the aid of which two sub-substrates forming the bipolar plate are bonded together. Alternatively, channels may also be provided to implement other functionalities.

It has been observed that problems may occur when operating fuel cells or flow batteries under certain operating conditions, especially at or after low temperatures. It is presumed that these problems are related to the bipolar plate used in the fuel cell or flow battery.

### SUMMARY

There may be a need for a bipolar plate or a fuel cell or flow battery equipped with a bipolar plate which may be operated reliably, including in particular under operating conditions at or after low temperatures. In particular, there may be a need for a bipolar plate that is simple in design, may be manufactured inexpensively and/or may be operated particularly robustly. There may further be a need for a method of manufacturing such a bipolar plate. In particular, there may be a need for a method whereby a bipolar plate may be manufactured inexpensively, with little effort and/or reliably.

Such a need may be met by the subject-matter of the independent claims. Advantageous embodiments are defined in the dependent claims, described in the following description and illustrated in the figures.

A first aspect of the invention relates to a bipolar plate for a fuel cell or flow battery, the bipolar plate comprising a substrate and a channel running from a channel entrance at a surface of the substrate into an interior of the substrate. A surface of the substrate is more strongly hydrophobic in a first area inside the channel adjacent to the channel entrance than in a second area.

A second aspect of the invention relates to a method of manufacturing a bipolar plate for a fuel cell or flow battery, the method comprising at least the following steps: providing a substrate having a structure such that a channel runs inside the substrate in the manufactured bipolar plate, the channel running from a channel entrance at a surface of the substrate into an interior of the substrate, and treating the surface of the substrate in a first area inside the channel adjacent to the channel entrance such that the surface of the substrate in the first area is more strongly hydrophobic than the surface of the substrate in a second area.

Without limiting the scope of the invention in any way, ideas and possible features relating to embodiments of the invention may be considered to be based, inter alia, on the ideas and findings described below.

Briefly and broadly summarised, a basic principle of the idea described herein may be understood as being based on the realisation that problems such as those observed in the operation of fuel cells or flow batteries, especially at or after low temperatures, could be due to the fact that water has penetrated into channels of the bipolar plate or water vapour has condensed in these channels and then frozen, giving rise to forces and/or damage in the bipolar plate due to thermally induced expansion occurring in this process. Whereas previously the aim has been to prevent water or water vapour from penetrating by sealing measures in or on the channels, it is herein proposed, as an alternative, to specifically make at least part of the surface of the substrate adjacent to the channel entrance, and preferably also exposed areas of the surface inside the channel, more strongly hydrophobic than is the case for other parts of the surface of the substrate. This should be able to prevent water from penetrating into exposed areas in the channel and/or from accumulating there through condensation.

Possible details of embodiments of the bipolar plate proposed herein and the manufacturing method are explained below.

The substrate with which the bipolar plate is formed is typically plate-shaped.

Accordingly, the substrate has a height and a width which are both significantly greater than the thickness of the substrate, that is to say, they exceed the thickness of the substrate by a factor of more than ten, for example. On an external surface, the substrate may have structures and/or textures, for example, to guide reaction fluids along predetermined paths over the substrate surface and/or to enlarge the substrate surface.

The substrate typically consists of a material with very good electrical conductivity or is at least provided with such a material on its surface.

For example, according to one embodiment, the bipolar plate or its substrate may be formed with or consist of a graphite-containing material.

As a carbon-containing material, graphite offers advantageous properties for many applications. When used in bipolar plates, for example, graphite offers very high electrical conductivity together with high thermal resilience and sufficiently high mechanical strength. Bipolar plates use, among other things, graphite-containing materials in which graphite particles are embedded in a polymer matrix. The graphite particles give the material desired electrical and/or thermal properties. Among other things, the polymer matrix serves to hold the graphite particles together mechanically. The polymer matrix may contain, for example, an epoxy resin. The graphite particles thus act as a filler and the polymer matrix as a type of binder. In addition to graphite particles and polymers, the material mixture may also contain other components, for example in the form of carbon black, other binding agents or similar. Advantageously, the graphite-containing material may have a graphite content of at least 60%, preferably at least 70% or even at least 80%. The percentages may refer to the volume. Due to the high graphite content, the material may offer, among other things, very good electrical conductivity, which is particularly advantageous when used to form bipolar plates. Examples and possible properties of graphite-containing materials are described, inter alia, in the applicant's earlier patent application PCT/EP2020/078489. The graphite-containing materials described therein may be used in embodiments of the bipolar plate described herein and may be made locally hydrophobic on their surface. The entire content of the earlier patent application is incorporated herein by way of reference.

At least one internal channel, i.e. a preferably elongated cavity, is formed in the substrate. The channel runs from a channel entrance on the surface of the substrate into the interior of the substrate. In other words, at the channel entrance, the channel opens into a volume or atmosphere surrounding the substrate. The channel runs from the channel entrance to the interior of the substrate and possibly to a channel outlet at another area of the surface of the substrate. The channel may have small cross-sectional dimensions compared to the thickness of the substrate. For example, the cross-sectional dimensions may be less than half, preferably less than one third, of the thickness of the substrate. The channel may be round or rectangular in cross-section or have any other geometry. The channel may be surrounded along its whole extent by material of the substrate of the bipolar plate. Alternatively, a portion of the extent may be covered by other material, such as a sealant, adhesive or glue introduced into the channel.

Conventionally, attempts have been made to seal channels in the substrate of a bipolar plate in such a way that no moisture may penetrate. For this purpose, for example, a sealant has been introduced into the channel, which fills and seals the channel at least at its channel entrance, preferably along the entire volume of the channel.

However, it has been observed that it may be difficult to seal the channel or its channel entrance reliably when manufacturing the bipolar plate. For example, it may be difficult to apply a sealant in such a way that the channel is completely filled or at least its channel entrance is sufficiently tightly sealed. In most cases, only very small tolerance windows are permissible, which may lead to unstable production processes. Furthermore, it is often necessary to apply an excessive amount of sealant, for example, so that excess sealant may leak out from the channel entrance and thereby sufficiently seal the channel entrance. However, in this case the excess sealant remains non-functional and thus causes excessive sealant consumption. In addition, it may be necessary to carry out rework and/or inspection of the sealed channel and/or clean the tools used. Moreover, the material requirements for the sealant may conflict with the technical requirements for the bipolar plate. Furthermore, there may be a risk of leaks developing between the channel and the sealant over time, for example due to thermal stresses and associated changes in shape.

To at least partially overcome the aforementioned problems or disadvantages, an alternative approach is described herein to prevent moisture from penetrating or accumulating inside the channel. Here, a partial area of the substrate surface inside the channel is specifically treated or specifically configured in such a way that greater hydrophobicity is established there than in other areas of the substrate surface, in particular than the other areas of the substrate surface inside the channel or adjacent to the channel. This more hydrophobic partial area is referred to herein as the first area. Less hydrophobic areas are referred to herein as second areas or third areas. The second area or the third area may be directly adjacent to the first area.

In the first area, the substrate surface may in particular be treated in such a way that a contact angle formed by a drop of water with the surface is greater than 40°, preferably greater than 60° or even greater than 80°. In particular, the substrate surface in the first area may be super-hydrophobic, i.e. a contact angle may be greater than 90°. In particular, the contact angle in the first area may be, for example, more than 5°, preferably more than 10°, more than 200 or even more than 300 larger than in the second area.

Due to the increased hydrophobicity of the substrate surface in the first area adjacent to the channel entrance, a risk of liquid, in particular water, penetrating the channel via the channel entrance may be greatly reduced.

According to one embodiment, it may be advantageous that the first area surrounds the channel entrance in an annular fashion. In other words, preferably the entire surface surrounding the periphery of the channel entrance may be specifically made more hydrophobic. The risk of liquid penetration may thus be further minimised. The hydrophobic channel entrance may act as a barrier for liquid and prevent liquid from entering the channel, for example due to capillary forces.

Furthermore, according to one embodiment, the first area may include parts of the substrate surface inside the channel that are in gas communication with the channel entrance. In other words, in addition to a partial area where it is adjacent to the channel entrance, the first area may run further into the interior of the channel and there include, in particular, parts of the substrate surface which may be reached by gas coming from the channel entrance. Gas communication between the channel entrance and the partial area of the first area located further inside the channel may take place here by gas flow and/or gas diffusion.

Since the highly hydrophobic first area also includes parts of the substrate surface inside the channel, it is also possible, among other things, to reduce the risk of vapour, in particular water vapour, entering the interior of the channel through the channel entrance and forming liquid droplets there by condensation.

According to one embodiment, the substrate of the bipolar plate is composed of two plate-shaped sub-substrates. The two substrates are bonded together over a bonding surface. An overflow channel runs adjacent to the bonding surface. The first area here runs at least along parts of the overflow channel. The second area runs along at least parts of the bonding surface. When manufacturing the bipolar plate, the two plate-shaped sub-substrates may first be provided as separate components and then bonded together across the bonding surface.

In other words, the bipolar plate may be constructed in two or more parts. Plate-shaped sub-substrates may first be prefabricated as individual components. Structures in the form of, for example, recesses, grooves or similar may be formed on one surface, which form channels in the resulting whole substrate after two sub-substrates have been joined together.

These structures may be configured to form bonding surfaces across which two adjacent sub-substrates stacked together may be bonded to one another. The bonding surfaces of the stacked sub-substrates may be configured in such a way that they oppose each other and run very close to each other and preferably in parallel with each other. When bonding the two sub-substrates, an adhesive may be applied to one or both of the opposed bonding surfaces.

The structures may further be configured in such a way that at least one overflow channel is formed next to the bonding surfaces. In the area of the overflow channel, a depression in the surface of a sub-substrate may be larger than in the area of the bonding surfaces. Accordingly, a surface of the overflow channel of one sub-substrate may be spaced further from an opposing surface of a second sub-substrate stacked above it than is the case for opposed bonding surfaces.

When bonding the two sub-substrates, the adhesive is first preferably applied exclusively to one or both of the bonding surfaces, but not into the overflow channel. However, when the two sub-substrates are pressed together, the adhesive may then flow laterally into the overflow channel and at least partially fill it. The overflow channel may thus take up excess adhesive. The two sub-substrates may thus be efficiently bonded together without excess adhesive preventing the sub-substrates from being pressed tightly together. If necessary, overflow channels may be disposed on both opposing sides of bonding surfaces.

Since the bonding surfaces are intended to serve to bond the two sub-substrates and the adhesive should therefore adhere well to these bonding surfaces, it may be expedient to form these bonding surfaces as second areas with relatively low hydrophobicity or even hydrophilicity. This allows the adhesive, which is generally processed in a liquid or flowable state, to adhere to the bonding surfaces over a large area and form an effectively adhering material bond with the bonding surfaces.

In contrast, it may be expedient to form a surface of the overflow channel with more strongly hydrophobic properties. Admittedly, part of this surface may eventually also be covered by adhesive, which oozes out laterally between the bonding surfaces. However, since the volume of the overflow channel is preferably chosen so that it is not completely filled with adhesive, at least part of the surface of the overflow channel may remain exposed. To prevent moisture from accumulating on this part of the surface, it may be configured as a first area with increased hydrophobicity.

Thus, according to one embodiment, in the finished bipolar plate according to one embodiment, the channel may be partially filled with a flowably processable adhesive. The first area is a portion of the surface inside the channel of the substrate where the adhesive is not in contact with the substrate. The second area of the substrate forms a portion of the surface inside the channel of the substrate where the adhesive is in contact with the substrate.

In other words, the bipolar plate composed of two sub-substrates, for example, may have a channel that is partially filled with an adhesive. The adhesive may be flowable while being processed and subsequently cross-link or solidify. Accordingly, the adhesive may adhere to bonding surfaces on the two sub-substrates and bond the two sub-substrates together. A portion of the surface of the sub-substrates inside the channel where the adhesive is in contact with the bonding surfaces may preferably be configured as a second area with low hydrophobicity. In contrast, a portion of the surfaces of the sub-substrates that are not covered by the adhesive after such a bonding process may be configured as a first area with strongly hydrophobic properties.

Preferably, the first area inside the channel runs along an entire surface of the substrate where the adhesive is not in contact with the substrate.

Put another way, the first area inside the channel is preferably dimensioned and disposed in such a way that, after bonding of the two sub-substrates with the aid of the adhesive, all surface areas of the substrate inside the channel that are not covered by the adhesive are strongly hydrophobic. Among other things, this may ensure that no weakly hydrophobic surfaces remain inside the channel on which, for example, penetrating water vapour could condense.

Various methods are generally known for treating the surfaces of a substrate in such a way that they acquire hydrophobic properties. For example, surfaces may be coated with a material that is highly hydrophobic, for example due to the absence of polar molecules and groups contained therein. Conversely, various suitable methods are known for treating the surfaces of a substrate to give them less hydrophobic or hydrophilic properties. For example, surfaces may be coated with a material that has at least some hydrophilicity due to polar molecules and groups contained therein. Alternatively, surfaces may be specifically oxidised, for example by treating them with fluorine or sulphur trioxide. Plasma treatment or corona treatment may also produce less hydrophobic or hydrophilic surface properties.

According to one embodiment, the first area of the substrate surface described herein may be treated by locally irradiating the substrate surface using a laser to give it more strongly hydrophobic properties.

A laser beam may be directed specifically at the first area of the substrate surface. The second area of the substrate surface may be left untreated or treated in another way to give it less hydrophobic properties. Using a laser, the first and second areas of the substrate surface may be configured locally to have hydrophobic properties of varying strength. The laser beam may also be specifically directed at very small areas. In contrast, it may be a difficult process to treat small areas using other technologies such as coating with a hydrophobic material.

Thus, according to one embodiment, the first area of the finished bipolar plate may be locally treated with a laser to produce the desired local increase in hydrophobicity.

The first area typically has characteristic microscopic properties due to irradiation with the laser beam. For example, an area that has been treated with the laser beam may have melted for a short period of time and, upon subsequent hardening, attained a structure and/or composition characteristic of the laser treatment. Alternatively or additionally, material may be removed locally, that is to say, ablated, from the surface with the help of a high-energy laser beam. A plasma may be generated close to the surface and material may then be vaporised. Additionally or alternatively, material may be chemically altered, that is to say, “cracked”, by thermal influences caused by the laser irradiation and then remain, for example, as a carbon structure or pass into the gas phase. Overall, laser treatment may create a surface texture that may be rougher than in areas that have not been laser-treated. Alternatively or additionally, a volume structure, in particular a crystal structure, for example, of the material treated with the laser may change in a way typical of laser treatment.

The laser may have properties that allow material of the substrate to be melted or ablated on the laser-treated surface. The laser may, for example, be a pulsed laser, in particular a short-pulse laser capable of emitting laser pulses with durations in the range of nanoseconds or less. The laser may be an infrared laser, for example.

According to one embodiment, the first area inside the channel may be treated to create a surface texture that produces a lotus effect.

The formation of a complex microscopic and nanoscopic surface structure may result in liquid droplets only being able to form a very small contact area with a surface so that they bead on the textured surface. This effect is also called the lotus effect and may represent a strongly hydrophobic or even a super-hydrophobic property of a surface. The surface texture may be formed by a multitude of tiny and closely spaced depressions and/or trenches.

For example, the surface texture may be created by scanning a laser beam along regular or irregular paths over the surface to be textured, briefly melting, agitating and/or ablating material on the surface.

According to one embodiment, the same laser used to treat the substrate surface in the first area to make it more hydrophobic may also be used to treat the substrate surface in the second area and/or in a third area of the surface.

It has been recognised that, with suitably adapted process control, the hydrophobic properties of a surface may be both strengthened and weakened through laser processing. It may therefore be advantageous specifically to create the first and second areas of differing hydrophobicity to be provided on the substrate of the bipolar plate by local treatment using the same laser. If necessary, a third area of the substrate surface may also be treated with the same laser. For example, the substrate surface in the third area may have a superficial layer removed by laser processing. Especially in the case of a graphite-containing material with a polymer matrix, for example, a polymer layer formed on the surface may be opened or removed by laser treatment. This may simplify process control and/or reduce the amount of equipment needed.

In particular, according to a more specific embodiment, laser parameters with which the laser is operated when treating the second and/or third area of the substrate surface may be chosen to be different to those selected when treating the first area of the substrate surface.

For example, it has been recognised that, when laser parameters are used that lead to the formation of a surface texture that produces a lotus effect, the first area may advantageously be configured to be strongly hydrophobic. When using other laser parameters, on the other hand, it has been observed that surface properties become less hydrophobic or even hydrophilic. It has been observed, for example, that when irradiated with very powerful, short laser pulses, a graphite-containing material may acquire hydrophilic properties. In this regard, another patent application is being filed by the applicant of the present application entitled “Verfahren zum Ausbilden einer hydrophilen Oberflache auf einem graphithaltigen Werkstoff und Verfahren zum Fertigen einer Bipolarplatte sowie Bipolarplatte und Brennstoffzelle bzw. Flussbatterie mit derselben” [Method of forming a hydrophilic surface on a graphite-containing material and method of manufacturing a bipolar plate and bipolar plate and fuel cell or flow battery using the same]. This further patent application describes details of a laser process as also used in embodiments of the bipolar plate described here and its manufacture using the same or similar methods. The entire content of the further application is incorporated herein by way of reference.

Embodiments of the bipolar plate disclosed herein may inhibit the penetration of liquid or moisture into channels of the substrate. This may prevent damage caused by expanding and freezing water, for example. Shorter application times, for example to apply adhesive between the sub-substrates to be bonded, and lower material usage may be possible. All in all, more robust processes, wider tolerance ranges, stable process capability, low process costs and/or less waste may be achieved.

It is noted that possible features and advantages of embodiments of the invention are described herein partly with reference to a bipolar plate and partly with reference to a method of manufacturing a bipolar plate. A person skilled in the art will recognise that the features described for individual embodiments may be transferred, adapted and/or interchanged in an analogous and suitable manner to other embodiments to arrive at further embodiments of the invention and possibly synergistic effects.

### BRIEF DESCRIPTION OF DRAWINGS

Advantageous embodiments of the invention are further explained below with reference to the accompanying drawings, in which neither the drawings nor the explanations are to be construed as limiting the invention in any way.

FIG. 1 shows a plan view of a bipolar plate according to an embodiment of the present invention.

FIG. 2 shows a cross-sectional view through a bipolar plate according to an embodiment of the present invention.

FIG. 3 shows an enlargement of the section marked A in FIG. 1.

FIG. 4 shows an enlargement of the section marked B in FIG. 2.

The figures are only schematic and not to scale. Identical reference signs in the different drawings denote identical or identically acting features.

### DETAILED DESCRIPTION

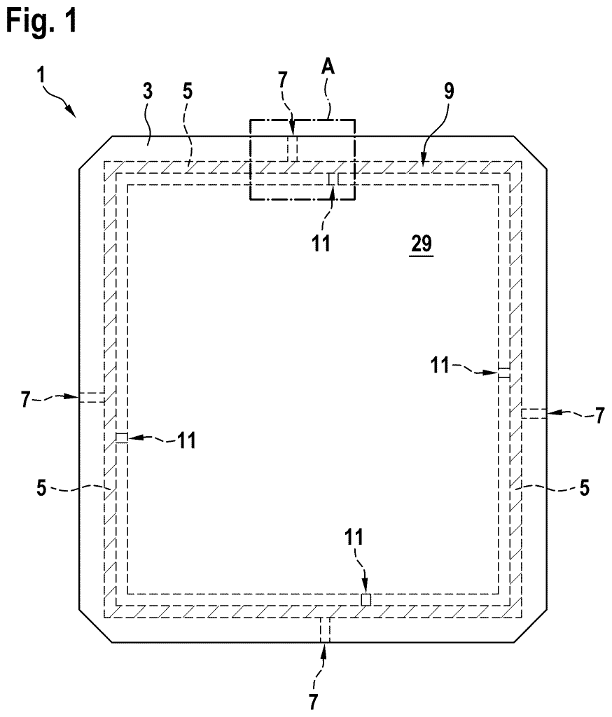

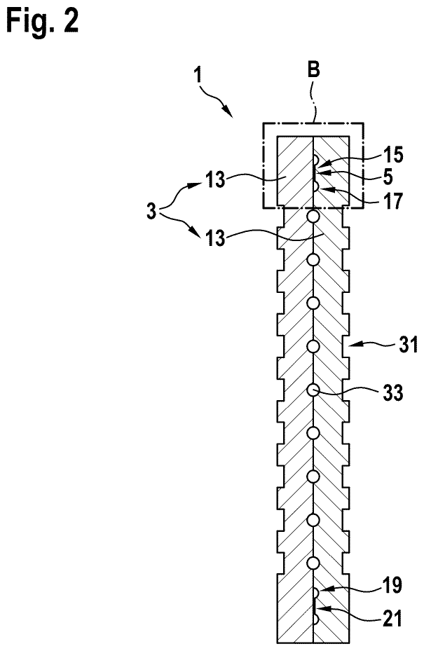

FIG. 1 shows a highly schematised plan view of a bipolar plate 1 of the type able to be used in a fuel cell or a flow battery. FIG. 2 shows a schematised cross-sectional view through the bipolar plate 1.

The bipolar plate 1 comprises a substrate 3, which may be made of a graphite-containing material, for example. A channel 5 runs in the substrate 3. The channel 5 runs from a channel entrance 7 into an interior 9 of the substrate 3. In the example shown, the channel 5 is annular and runs close to an outer periphery of the bipolar plate 3. A plurality of channel entrances 7 are provided. The channel entrances 7 may serve as openings for ventilation of the annular area of the channel 5 and run towards an outer edge of the substrate 3. In the example shown, further openings are configured which may also be referred to as channel entrances 7 or alternatively as channel outlets 11 and which are directed away from the outer edge and towards a centre of the substrate 3.

A first area 19 of the surface of the substrate 3 inside the channel 5 is treated or configured so as to be more hydrophobic than a second area 21. The first area 19 runs on the one hand as far as the channel entrance 7 and preferably surrounds the channel entrance 7 in an annular fashion. On the other hand, the first area 19 inside the channel 5 also partly runs into the interior 9 of the substrate 3, in particular where an inner surface of the substrate is exposed inside the channel 5, so that gas or vapour coming from the channel entrance 7 may reach this part of the first area 19. Furthermore, the first area 19 may also run as far as the channel outlet 11 and also preferably surround it in an annular fashion.

Two sub-substrates 13 may be provided to manufacture the bipolar plate 1. In the sub-substrates 13, close to the outer periphery of the sub-substrates 13, by means of local depressions, structures may be configured which on the one hand form a bonding surface 15 and on the other hand form an overflow channel 17 on either side adjacent to the bonding surface 15. The bonding surface 15 and the overflow channels surround a central area of the bipolar plate 1 in an annular fashion. The bonding surface 15 is configured as a second area 21 with lower hydrophobicity or even hydrophilicity, whereas surfaces bordering the overflow channel 17 are configured as a first area 19 with greater hydrophobicity. On outward-facing surfaces, the sub-substrates 13 of the bipolar plate 1 have surface structures 31 in their central area which serve, for example, for the targeted conduction of reaction gases (only indicated in FIG. 2 and not illustrated in FIG. 1 for the sake of clarity). On inward-facing surfaces, the sub-substrates 13 have other surface structures, for example to form cooling channels 33 inside the bipolar plate 1.

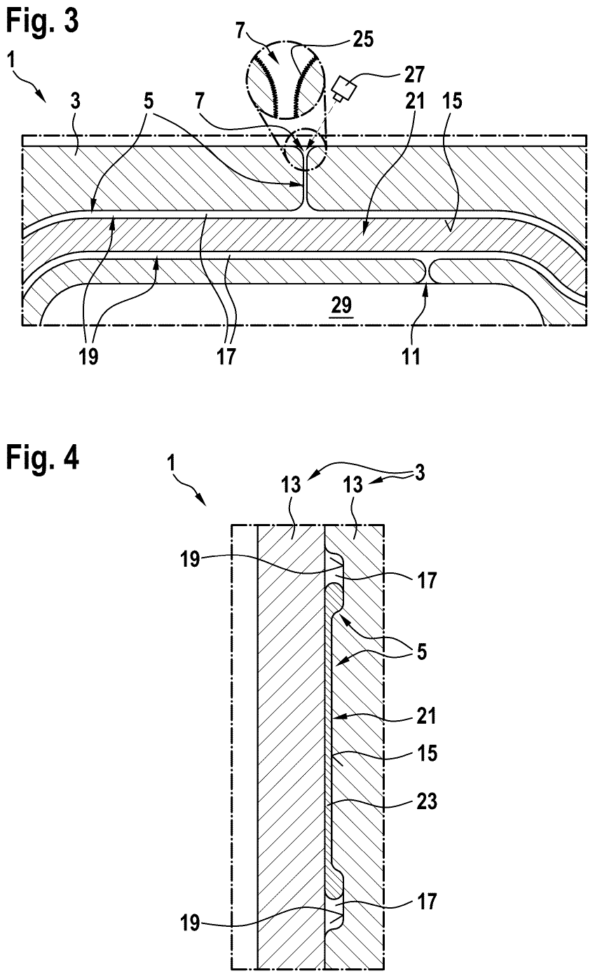

The surface of the substrate 3 in the first area 19 may be irradiated with a laser 27, for example. Laser parameters of this laser 27 may be set in such a way that microscopic and/or nanoscopic structures of a surface texture 25 are formed on the surface of the first area 19, which cause a lotus effect and/or a chemical and/or physical effect and thus strong hydrophobicity. In FIG. 3, such a surface texture 25 is schematically symbolised in a locally enlarged section.

The second area 21 may either not be irradiated with the laser 27 or other laser parameters may be set which cause this second area 21 to have less hydrophobic or hydrophilic properties. Similarly, a third area 29 may also be treated with the laser 27 by setting suitable laser parameters in order to, for example, specifically produce strongly hydrophilic properties there.

In order to bond the two sub-substrates 13 together, an adhesive 23, for example in the form of a flowably processable bonding agent, is applied between the bonding surfaces 15. Due to the low hydrophobicity or hydrophilicity of the second area 21 configured there, this adhesive 23 may adhere strongly to the bonding surfaces 15. When the two sub-substrates 13 are pressed together, excess adhesive 23 may flow laterally into the overflow channels 17. However, it is not necessary to apply the adhesive 23 with a large excess, as in the conventional methods sometimes used, such that the overflow channels 17 up to the channel entrance 7 are entirely filled with adhesive 23 in order to seal the entire channel 5. Instead, parts of the overflow channels 17 may remain exposed and thus their inner surface may remain uncovered. The strong hydrophobicity of the first area 19 formed there means that moisture cannot be deposited on such exposed surfaces inside the channel 5, even though they are in gas communication with the channel entrance 7. Frost damage caused by freezing moisture inside the channel 5 may thus be avoided.

Finally, it should be noted that terms such as “having”, “comprising”, etc. do not exclude other elements or steps, and terms such as “one” or “a” do not exclude a plurality. It should further be noted that features or steps that have been described with reference to one of the above embodiments may also be used in combination with other features or steps of other embodiments described above. Reference signs in the claims are not to be considered as limitations.

### LIST OF REFERENCES

1 Bipolar plate
3 Substrate
5 Channel
7 Channel entrance
9 Interior of the substrate
11 Channel outlet
13 Sub-substrate
15 Bonding surface
17 Overflow channel
19 First area
21 Second area
23 Adhesive
25 Surface texture
27 Laser
29 Third area
31 Surface structures
33 Cooling channels

1-15. (canceled)

16. A bipolar plate for a fuel cell or a flow battery, wherein the bipolar plate comprises:
a substrate, and
a channel running from a channel entrance at a surface of the substrate into an interior of the substrate,
a surface of the substrate being more hydrophobic in a first area inside the channel adjacent to the channel entrance than in a second area,
wherein the first area annularly surrounds the channel entrance.

17. The bipolar plate according to claim 16, wherein the first area comprises parts of the surface of the substrate inside the channel that are in gas communication with the channel entrance.

18. The bipolar plate according to claim 16,
wherein the substrate of the bipolar plate is composed of two plate-shaped sub-substrates,
the two sub-substrates being bonded together across a bonding surface,
and an overflow channel running adjacent to the bonding surface,
the first area running at least along parts of the overflow channel and
the second area running at least along parts of the bonding surface.

19. The bipolar plate according to claim 16,
wherein the channel is partially filled with a flowably processable adhesive,
the first area forming a portion of the surface inside the channel of the substrate where the adhesive is not in contact with the substrate, and
the second area of the substrate forming a portion of the surface inside the channel of the substrate where the adhesive is in contact with the substrate.

20. The bipolar plate according to claim 19,
wherein the first area runs inside the channel along an entire surface of the substrate where the adhesive is not in contact with the substrate.

21. The bipolar plate according to claim 16,
wherein the first area is locally treated by means of a laser to provide a local increase in hydrophobicity.

22. The bipolar plate according to claim 16,
wherein the first area has a surface texture creating a lotus effect.

23. The bipolar plate according to claim 16,
wherein the bipolar plate is formed with a graphite-containing material.

24. A method of manufacturing a bipolar plate for a fuel cell or a flow battery, the method comprising:
providing a substrate having a structure such that a channel runs inside the substrate in the manufactured bipolar plate, the channel running from a channel entrance at a surface of the substrate into an interior of the substrate, and
treating the surface of the substrate in a first area inside the channel adjacent to the channel entrance such that the surface of the substrate in the first area is more strongly hydrophobic than the surface of the substrate in a second area,
wherein the first area annularly surrounds the channel entrance.

25. The method according to claim 24,
wherein the substrate is provided with two plate-shaped sub-substrates,
a bonding surface being formed on the two plate-shaped sub-substrates and an overflow channel being formed adjacent to the bonding surface,
the first area running at least along parts of the overflow channel, and the second area running along at least parts of the bonding surface,
the method further comprising bonding the two plate-shaped sub-substrates together across the bonding surface.

26. The method according to claim 24,
wherein the first area is treated by locally irradiating the surface of the substrate by means of a laser.

27. The method according to claim 26,
the method further comprising treating the substrate with the laser in the second area of the surface of the substrate and/or in a third area of the surface of the substrate.

28. The method according to claim 27,
wherein the laser is operated with different laser parameters when treating the second and/or third area of the surface of the substrate than when treating the first area of the surface of the substrate.

29. The method according to claim 24,
wherein the first area of the surface of the substrate is formed by treating with a surface texture producing a lotus effect.
